(19) United States
(12) Patent Application Publication
(10) Pub. No.: US 2012/0013783 A1
(43) Pub. Date: Jan. 19, 2012

(54) PHOTGRAPHING SUPPORT SYSTEM, PHOTOGRAPHING SUPPORT METHOD, SERVER PHOTOGRAPHING APPARATUS, AND PROGRAM

(75) Inventor: Takenori Asami, Kawasaki-shi (JP)

(73) Assignee: CANON KABUSHIKI KAISHA, Tokyo (JP)

(21) Appl. No.: 13/180,178

(22) Filed: Jul. 11, 2011

(30) Foreign Application Priority Data
Jul. 13, 2010 (JP) 2010-159009

(51) Int. Cl. H04N 5/225

(52) U.S. Cl. 348/333.02; 348/E05.024

(57) ABSTRACT

Photographing support that supports a photographer in taking more photographs appropriate for an album such as photographs including good combinations of subjects or photographs taken evenly throughout an event is realized by calculating a point value of a photographing frame captured by a photographing apparatus considering a combination of subjects to be photographed, an importance level of the subject to be photographed, and an importance level of photographing time, and presenting the acquired point value to the photographer.

### BACKGROUND OF THE INVENTION

1. Field of the Invention

The present invention relates to a photographing support system and a photographing support method.

2. Description of the Related Art

As a conventional technique for supporting photographers when the photographers capture images for albums, Japanese Patent Application Laid-Open No. 2008-252494 discusses a method that displays an instruction image on a display of a photographing apparatus. The instruction image shows the order the images should be taken, the composition of the images, and the state of the subject in the images. According to this conventional technique, the photographer can understand in advance the content of photographs that are to be shot, by referring to the instruction image.

However, the content of photography, which is determined and presented in the form of an instruction image, is not always appropriate for the images to be included in an album. For example, in a case an album is presented to a guest of an event, such as a wedding reception, photographs of the guest will be taken so that an album including such a guest can be produced. Photographs required for such an objective are, for example, photographs of good friends in a same group. This is because, for the person who receives the album, photographs taken with a friend of a same group are desirable compared to photographs taken with someone the person has never met before. On the other hand, if an album of a school trip is to be produced, since the students know each other, photographs of a wide variety of classmates as well as a particular group of friends are desirable in producing a memorable album.

According to the conventional technique, although the photographer can recognize compositions for shooting and scenes to be captured, according to the instruction image, the photographer is unable to know whether the subjects currently within the frame belong to the same group. In other words, the conventional technique is unable to appropriately assist the photographer when photographing each guest of an event.

Further, in capturing an image of guests of an event, it is desirable to evenly capture the images of the guests throughout the event. For example, if a wedding ceremony, a wedding reception, and an after-party are arranged on one day, the photographer is asked to capture images of guests evenly throughout such events.

According to the conventional technique discussed in Japanese Patent Application Laid-Open No. 2008-252494, it is necessary to prepare in advance the order the images are to be taken and the instruction image. However, it is not practical to prepare instruction images of all the guests who are photograph targets considering the photographing time. Further, even if the instruction images of all the guests considering the photographing time are prepared, if a large number of guests are invited, it would be difficult for the photographer to capture a great number of images while referring to a great number of instruction images.

As described above, there is a demand for a method that presents the photographer with evaluation information which is helpful when the photographer needs to determine whether he should capture a subject currently appearing in the frame in the photographing apparatus, which changes from moment to moment, in taking photographs for an album.

### SUMMARY OF THE INVENTION

According to an aspect of the present invention, a photographing support method for supporting photographing performed by a photographing apparatus includes identifying an object within a photographing frame, evaluating a whole photographing frame based on an evaluation condition set for each object within the photographing frame which has been identified, and presenting an evaluation result of the evaluation to a photographer as support information.

According to another aspect of the present invention, a server for outputting support information used for supporting photographing performed by a photographing apparatus to the photographing apparatus includes an acquisition unit configured to acquire a photographing frame, an identification unit configured to identify an object within the acquired photographing frame, an evaluation unit configured to evaluate a whole photographing frame based on an evaluation condition set for each object within the photographing frame which has been identified, and an output unit configured to output an evaluation result of the evaluation unit to the photographing apparatus as support information.

According to yet another aspect of the present invention, a photographing apparatus presenting information used for supporting photographing performed by a photographer includes an identification unit configured to identify an object within a photographing frame, an evaluation unit configured to evaluate a whole photographing frame based on an evaluation condition set for each object within the photographing frame which has been identified, and a presentation unit configured to present an evaluation result of the evaluation unit to a photographer as support information.

According to the present invention, a photographer can easily determine whether to perform photographing according to presented support information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a photographing support system.

FIG. 2 is a flowchart describing photographing support data presentation processing.

FIG. 3A illustrates an example of data of subjects combination table.

FIG. 3B illustrates an example of group information.

FIG. 4 illustrates an example of a photographing time condition concerning time elapsed from when photographing has been started.

FIG. 5A illustrates an example of a condition of a subject to be photographed indicating an importance level of the subject.

FIG. 5B illustrates an example of a point value corresponding to the importance level of the subject to be photographed.

FIG. 5C illustrates an example of a photographing time as photographing condition of the subject to be photographed.

FIG. 6A is a presentation example of photographing support data.

FIG. 6B is another presentation example of the photographing support data.

FIG. 6C is another presentation example of the photographing support data.

FIG. 7 illustrates a face position of a person to be photographed.

FIG. 8 illustrates a presentation example of a warning.

FIG. 9 illustrates an example of a message which is displayed corresponding to a frame point.

FIG. 10 illustrates an example of a setting screen which is displayed when a condition is registered.

FIG. 11A illustrates a subjects combination table before an image is photographed.

FIG. 11B illustrates the subjects combination table which is updated after a photograph including subjects A, B, and C is taken.

FIG. 12 is a flowchart illustrating photographing support data presentation processing according to a fourth exemplary embodiment of the present invention.

FIG. 13A is a presentation example of the photographing support data according to the fourth exemplary embodiment.

FIG. 13B is another presentation example of the photographing support data according to the fourth exemplary embodiment.

FIG. 14 is a function block diagram of a photographing apparatus executing the photographing support.

### DESCRIPTION OF THE EMBODIMENTS

Various exemplary embodiments, features, and aspects of the invention will be described in detail below with reference to the drawings.

Configurations of exemplary embodiments below are merely examples and shall not be construed as limiting the configuration illustrated in the present invention.

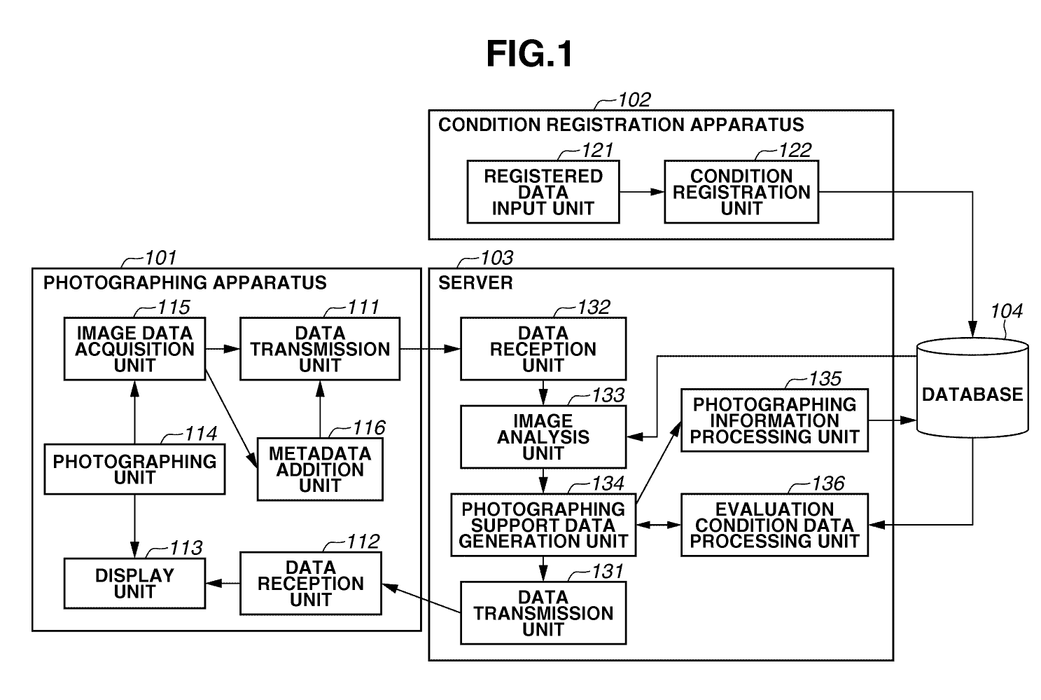

According to a first exemplary embodiment, based on a combination of subjects to be photographed currently in the frame, a support message indicating whether the photographer should take the image of the subjects in the frame is presented to the photographer. FIG. 1 is a block diagram illustrating a configuration of a photographing support system according to the present embodiment. According to the present embodiment, as illustrated in FIG. 1, the photographing support system includes a photographing apparatus, a server, a condition registration apparatus, and a database.

A photographing apparatus 101 is an apparatus, such as a camera, that captures an image. Each unit of the photographing apparatus 101 is realized by a control device, such as a central processing unit (CPU), that performs control of hardware, processing of information, and calculation based on a control program stored in a storage unit (not shown).

A data transmission unit 111 and a data reception unit 112 include, for example, a wireless local area network (WLAN) communication device. The data transmission unit 111 transmits image data to a server. The data reception unit 112 receives photographing support data (support information) described below from the server. A display unit 113 displays image data acquired by a photographing unit 114 described below on a display device, such as a liquid crystal display (LCD), of the photographing apparatus 101. Further, the photographing support data (support information) received by the data reception unit 112 is also displayed on the display screen by the display unit 113. In this manner, the photographing support data is presented to the photographer.

The photographing unit 114 includes an image sensor, such as a charge coupled device image sensor (CCD), which converts a light beam that passed through a lens into an electric signal, as well as an analog-to-digital (A/D) conversion device, which further converts the electric signal obtained by the image sensor into a digital signal. An image data acquisition unit 115 converts the digital signal output from the photographing unit 114 into image data. The light from the subject acquired by the photographing unit 114 is repeatedly converted into image data in an extremely short cycle while the power of the photographing apparatus 101 is turned on. The generated image data is temporarily stored in a storage unit such as a random access memory (RAM). The acquired image data is transmitted to the data transmission unit 111. When photographing processing is executed, the generated image data is also transmitted to a metadata adding unit 116.

When the photographer holds down a shutter button (not shown), the photographing processing is executed. When the photographing processing is started, the metadata adding unit 116 adds image information to the image data which has been acquired. The added image information is information of the captured image such as photographing time. The exchange of image between the photographing unit 114 and the image data acquisition unit 115, the image data acquisition unit 115 and the data transmission unit 111, and the photographing unit 114 and the display unit 113 is performed even when the shutter button is not pressed. In other words, while the power is turned on, regardless of whether the shutter button is pressed or not, the image data obtained by the photographing apparatus 101 is immediately transmitted to a server 103 via the data transmission unit 111.

A condition registration apparatus 102 is an information processing apparatus such as a computer, and is used for registering various conditions described below in a database 104. Each unit included in the condition registration apparatus 102 is realized by a control device such as a CPU performing control of hardware, processing of information, and calculation based on a control program stored in a storage unit (not shown)

A registration data input unit 121 includes a display device and an input device. The display device displays a user interface (UI) which is used when the user inputs registration data. The content of the input is also displayed on the display device. The input device, which is, for example, a mouse or a keyboard, is used when the user inputs registration data. The registration data input unit 121 stores the registration data input by the user in a storage unit such as a RAM. A condition registration unit 122 reads out the data input in the registration data input unit 121, generates condition registration data, and outputs the registration data to the database 104 so that it is stored in the database. The condition registration data is evaluation conditions used for evaluating the whole photographing frame such as group information and data of subjects combination table described below.

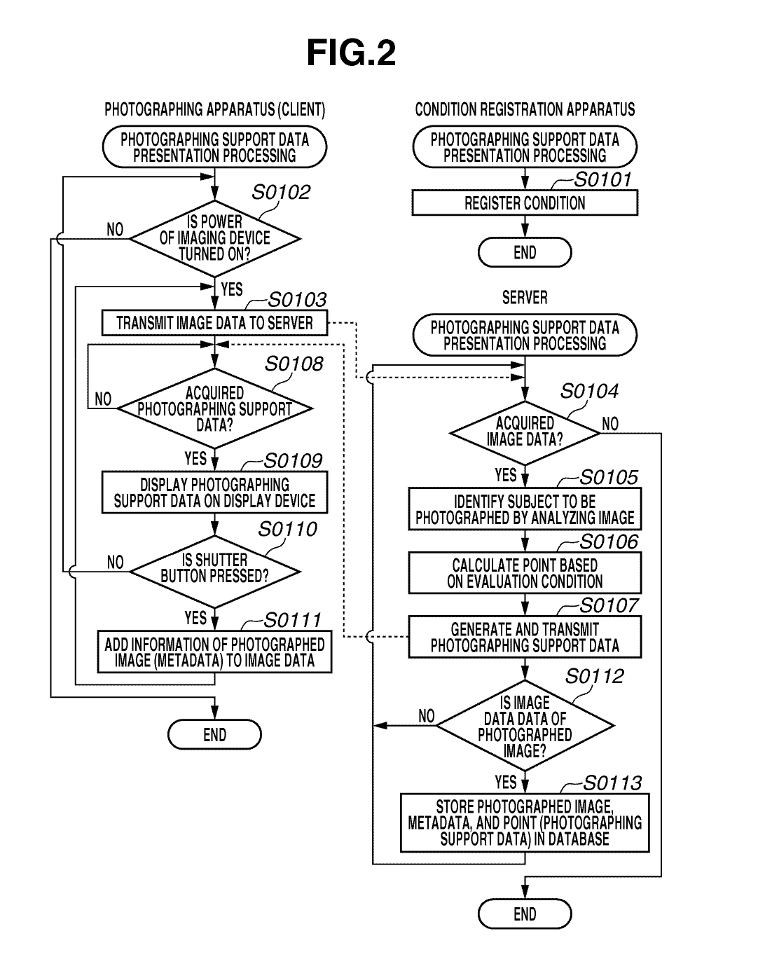

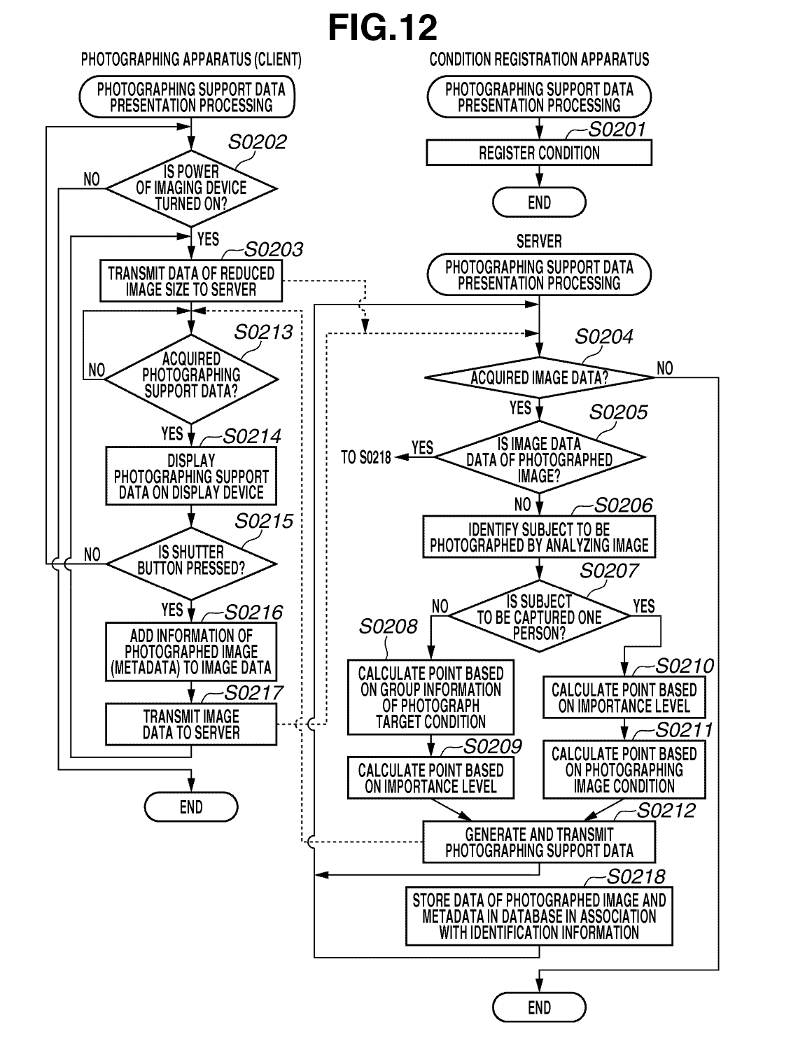

The server 103 is, for example, an information processing apparatus such as a computer. The server 103 communicates with the photographing apparatus 101 and provides photographing support data (support information). Each unit of the server 103 is realized by a control device such as a CPU performing control of hardware, processing of information, and calculation based on a control program stored in a storage unit (not shown). Further, processing performed by the server 103 described with reference to the flowcharts in FIGS. 2 and 12 is realized by the control device such as a CPU performing control of hardware, processing of information, and calculation based on a control program stored in a storage unit (not shown).

Each of a data transmission unit 131 and a data reception unit 132 includes a communication device such as a communication device for wireless local area network (LAN). The data transmission unit 131 transmits photographing support data (support information) described below to the photographing apparatus 101. The data reception unit 132 receives image data from the photographing apparatus 101. An image analyzing unit 133 identifies a subject to be photographed in a photographing frame according to face detection processing or face recognition processing. The photographing frame is an image obtained from the image data which the image analyzing unit 133 has acquired from the data reception unit 132. Further, the image analyzing unit 133 executes image analysis processing. From a face area which has been detected, the image analyzing unit 133 acquires a position or a size of the face area, detects facial expression, and further detects face orientation.

A photographing support data generation unit 134 generates the photographing support data (support information) based on various condition values and a result obtained from the image analysis. The photographing support data is information which is useful when the photographer performs photographing, and includes point values, character strings, and images. The photographing support data generation unit 134 obtains a processing result from an evaluation condition data processing unit 136. Further, the photographing support data generation unit 134 obtains a result of the analysis from the image analyzing unit 133. The photographing support data generation unit 134 generates the photographing support data by selecting and combining necessary values from the acquired results. A photographing information processing unit 135 stores data and information in the database 104. The data and information is, for example, image data of the photograph taken by the photographing apparatus, photographing time, the number of photographs that have been taken, and information such as a result of image analysis generated by the server 103.

The evaluation condition data processing unit 136 evaluates the whole photographing frame according to a point which is calculated based on various evaluation conditions such as a combination of the subjects to be photographed, importance level, face orientation, and facial expression. The evaluation conditions are based on conditions of the photograph targets such as a group condition and a time condition, which are stored in the database 104. According to a request from the photographing support data generation unit 134, the evaluation condition data processing unit 136 reads out a condition value that matches the condition from the database and calculates the point value. The calculated point value can be referenced by the photographing support data generation unit 134.

The database 104 is a storage unit such as a hard disk drive (HDD) and is controlled by the condition registration apparatus 102 and the server 103. Data used for evaluation conditions including various evaluation condition values which have been registered, photographic images which have been captured, and a number of images which have been captured can be stored in the database 104.

Next, an operation example of the photographing support system according to the present embodiment will be described. First, photographing support data presentation processing according to the present embodiment will be described with reference to the flowchart illustrated in FIG. 2.

In step S0101 in FIG. 2, the condition registration apparatus 102 displays the UI so that the user can register facial images of all the people who can be the subjects to be photographed and the photographing condition of the subjects to be photographed. The facial images are referential images of the subjects to be photographed. The photographing condition of the subject to be photographed is a condition used for acquiring the point value of the subject to be photographed.

Next, the registration procedure of the photographing condition of the subject to be photographed will be described. Suppose there are 12 subjects to be taken (subjects A to L). The registration data input unit 121 of the condition registration apparatus 102 displays the UI so that the user can register the names of the persons who are the subjects to be photographed. Then, the registration data input unit 121 obtains identification information of the subjects to be photographed such as the names of the subjects A to L and their face images according to the input by the user. Further, the user is asked to select members of a same group, and register the members and the name of the group.

For example, if the event is a wedding ceremony, according to an instruction presented by the registration data input unit 121, the user registers group names such as “groom's friends” and “bride's family” as the groups the user has selected. Further, the registration data input unit 121 displays a message asking the user to set an importance level of the photography of the group which has been set. The importance level of the photography indicates whether photographing of the selected group (or the selected individual) should be aggressively performed.

According to this system, the higher the importance level of the photography is, the greater support the photographer receives to take the image of the group (or the individual). A pull-down menu is provided on the UI by the registration data input unit 121 so that the user can select the importance level of the photography. For example, the user selects the importance level from levels 1 to 3. In this manner, a group, which will be the basis of the evaluation condition, is set for each subject.

When the registration data input unit 121 acquires the registration data input by the user, the data is transmitted to the condition registration unit 122. Then, the condition registration unit 122 generates group information and data of the subjects combination table.

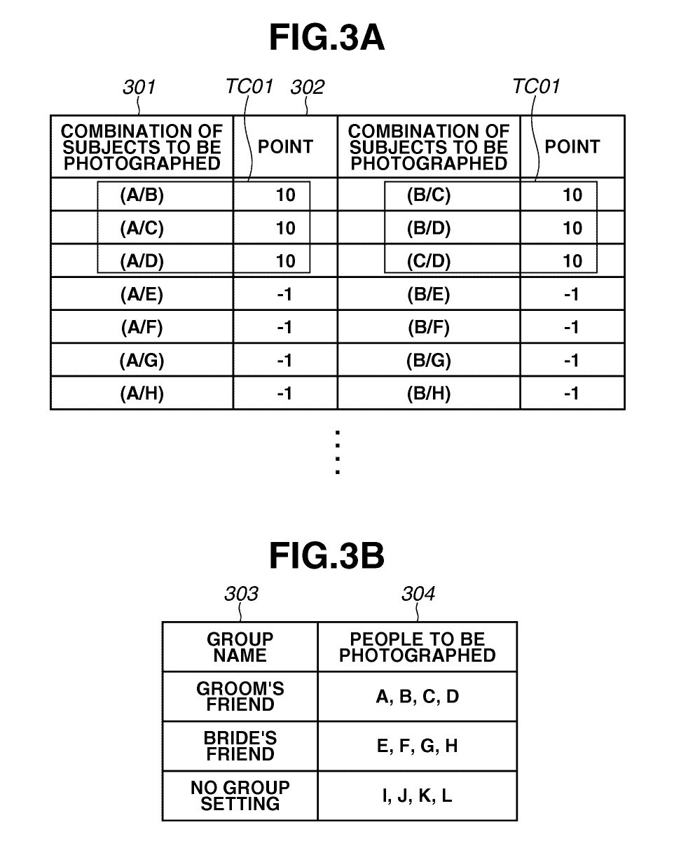

FIG. 3A illustrates an example of the data of the subjects combination table. A “combination of subjects to be photographed” 301 shows each combination of the registered subjects to be photographed. A point value 302 indicates a point value which serves as photographing support information when subjects of the combination corresponding to the combination of subjects to be photographed 301 exist within the frame of the photographing apparatus 101.

FIG. 3B illustrates an example of the group information. A group name 303 is set by the user and a “subjects to be photographed” 304 presents the names of the people of the group corresponding to the group of the group name 303. The people corresponding to the subjects to be photographed are the subjects A to L. Among these people, the subjects A, B, C, and D belong to a same group. The group name 303 of this group is “groom's friends”. Similarly, the subjects E, F, G, and H belong to a same group. The group name 303 of this group is “bride's friends”. No group is set for the subjects I, J, K, and L.

The point values enclosed by boxes TC01 in FIG. 3A are the point values of the combination of the subjects to be photographed in the same group (subjects A to D). The point values of this group are set by the condition registration unit 122 according to the importance level of the photography of the group registered by the user. Although the point value of each of the combination of the subjects to be photographed of the same group (subjects A to D) is set to “10” in FIG. 3A, the point value can be changed according to the importance level of the photography. The point value can also be set by the user. Further, the condition registration unit 122 sets a negative value if the subjects to be photographed are from different groups or if one of the subjects does not belong to a group.

As described above, the condition registration unit 122 stores in the database 104 the generated data of the subjects combination table and the data of the conditions of the subjects to be photographed that defines the group condition together with the facial images which serve as a registration reference.

Referring back to step S0102 in FIG. 2, the CPU of the photographing apparatus 101 determines whether the power of an imaging device is turned on. If the power is turned on (YES in step S0102), the processing proceeds to step S0103. If the power is not turned on (NO in step S0102), the processing ends. In step S0103, the image data acquisition unit 115 generates image data from the light of the subject. The photographing unit 114 of the photographing apparatus 101 obtains this light via the lens. Then, the data transmission unit 111 transmits the generated image data to the server 103. This processing is performed before the shutter of the photographing apparatus 101 is pressed. In other words, this processing is performed in the state before the photographing processing is executed.

The server 103 is always in a stand-by mode regarding transmission of data from the photographing apparatus 101. In step S0104, the CPU of the server 103 determines whether the data reception unit 132 of the server 103 has received the image data (frame) from the photographing apparatus 101.

In step S0104, if it is determined that the image data has been received (YES in step S0104), the processing proceeds to step S0105. If it is not determined that the image data has been received (NO in step S0104), the processing ends. In step S0105, the image analyzing unit 133 performs the face detection processing and the face recognition processing of the received image data and identifies the subject to be photographed in the photographing frame. The image analyzing unit 133 identifies the person in the image data by referring to the reference face image stored in the database 104, and stores the identification information of the identified person and the position of the person in the image data in a storage unit such as a RAM (not shown). Similarly, if a person other than the registered subject is detected, information indicating that a person other than the subject to be photographed has been detected and the position of that person in the image data are stored in a storage unit.

In step S0106, the evaluation condition data processing unit 136 acquires the identification information useful in identifying the person in the image data, and performs the calculation processing of the point value based on the photographing condition of the subject to be photographed, which is the evaluation condition. The calculation processing of the point value based on the photographing condition of the subject to be photographed is based on the combination of the subjects to be photographed in the acquired image data, and is processing for obtaining a point value which is an evaluation result of whether to perform or not perform the photographing of the frame. Such a point value is hereinafter referred to as a frame point value.

The point value of a frame according to the photographing condition of the subject to be photographed is a total of the point values corresponding to the combination of the subjects to be photographed of the persons in the image. For example, the point value when the subjects A, B, and C are in the image data is a total of the point values of the combination of the subjects to be photographed (three combinations being (A/B), (A/C), and (B/C)). According to the subjects combination table illustrated in FIG. 3A, since (A/B), (A/C), and (B/C) are combinations of the subjects in the same group, the point value of each combination is 10. Thus, the point value of the frame where the subjects A, B, and C are included is a total of each of the three point values, that is, 30 (=10+10+10).

Further, the point value of the frame where the subjects A, B, and E are included in the image data is 10 for (A/B) as it is a combination of the same group and −1 each for (A/E) and (B/E) as they are combinations of persons from a different group. In other words, the frame point value of an image including the subjects A, B, and E will be a total of the three point values, that is, 8 (=10−1−1). In this manner, according to the point values associated with all the subjects to be photographed within a photographing frame, one point value for the frame or one frame point value is acquired. In other words, the frame can be evaluated.

Further, the evaluation condition data processing unit 136 sets a greater negative value for a combination of an unregistered person and a subject to be photographed compared to the negative value assigned to a combination of subjects to be photographed of different groups. This is to encourage the photographer to capture the images of the subjects to be photographed.

As described above, the evaluation condition data processing unit 136 calculates the point value based on the identification information used for identifying the person in the image data and the subjects combination table.

In step S0107, the photographing support data generation unit 134 generates the photographing support data (support information) by using the point value, which is the result of the evaluation of the frame based on the acquired combination of subjects to be photographed. The photographing support data is data including the frame point value, which is useful when the photographer performs photographing, based on the subject to be photographed and the composition of the image support. The photographing support data generation unit 134 generates the photographing support data displayable on the imaging device by using the frame point value and the registration data. Further, the data transmission unit 131 outputs the generated photographing support data to the photographing apparatus 101.

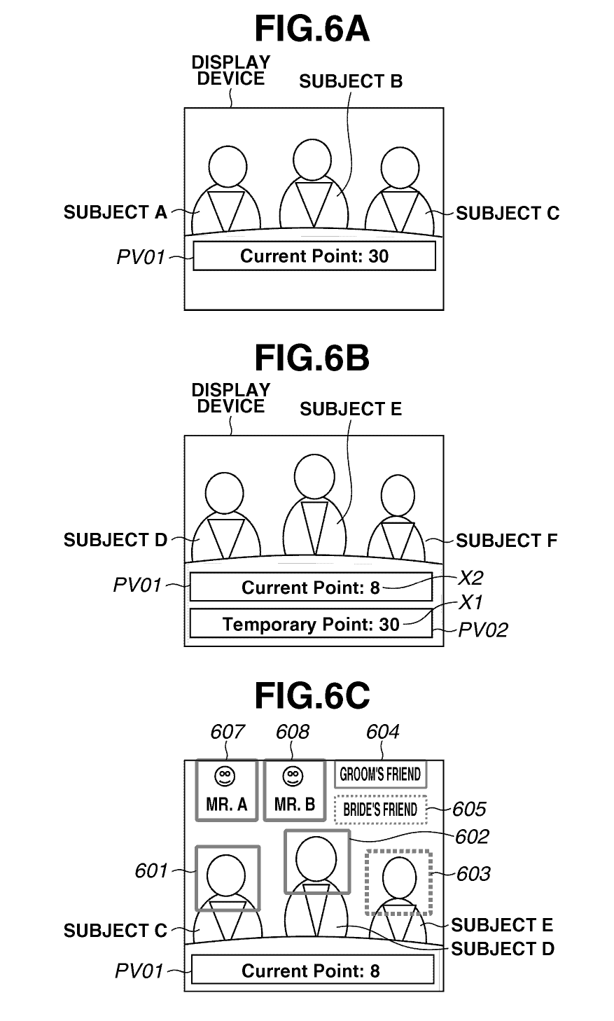

In step S0108, the CPU of the photographing apparatus 101 determines whether the data reception unit 112 has received the photographing support data. If the data reception unit 112 has received the photographing support data (YES in step S0108), the processing proceeds to step S0109. If the data reception unit 112 has not yet received the photographing support data (NO in step S0108), the processing in step S0108 is repeated. In step S0109, the display unit 113 displays the acquired photographing support data on the display device and presents the data to the photographer. Examples of the presentation of the photographing support data are illustrated in FIGS. 6A to 6C.

FIGS. 6A to 6C illustrate examples of the presentation of the photographing support data on the display device of the photographing apparatus 101. The photographing support data is superposed on the image acquired by the photographing unit 114. In FIG. 6A, the subjects A to C are within the frame and the frame point value is displayed in a region PV01. The photographer can reference the point and determine that many of the subjects to be photographed that belong to a same group are within the frame if the point is high. Thus, whether to perform photographing or not can be easily determined.

FIG. 6B illustrates another example of the presentation of the photographing support data. According to this example, the photographing apparatus 101 includes a temporary storage button M. If the CPU detects that the temporary storage button M has been selected, the CPU stores a frame point value X1 of the image data acquired by the photographing unit 114 at that timing in a storage unit such as a RAM. Then, the CPU simultaneously displays on the display device a frame point value X2 of the current frame and the frame point value X1 which has been stored. The stored point value can be displayed at a display position different from the display position on the screen where the image data is displayed.

FIG. 6B illustrates a display example after the photographer has pressed the temporary storage button M of the photographing apparatus in a state where the subjects A to C are included in the frame. The frame point value X1 of that frame is displayed in a region PV02 and continuously displayed in that region even if the subjects within the frame are changed to the subjects D to F. On the other hand, the frame point value X2 of the frame where the subjects D to F are included is displayed in a different region (the region PV01). Thus, the photographer can compare the frame point values X1 and X2. In this manner, a frame of a higher point value can be found more easily. Accordingly, the frame can be selected more easily and the photographing can be performed more efficiently.

Further, another example of the photographing support data presentation is illustrated in FIG. 6C. FIG. 6C illustrates a display example where the subjects C to E are in the frame. The subjects C and D belong to a same group but the subject E belongs to a group different from the group of the subjects C and D.

Frames 601 and 602 are face frames for the subjects C and D. The frames 601 and 602 have a same color or style so that the photographer can easily determine that they belong to the same group. A frame 603 is a face frame for the subject E. The frame 603 has a color or style different from that of the frames 601 and 602 so that the photographer can easily understand that it belongs to a group different from the group of the subjects C and D.

Regions 604 and 605 are where the group names of the groups corresponding to the subjects are displayed. The group name of the subjects C and D in the frames is displayed in the region 604. The region 604 is framed with a color or style same as the color or style of the frames 601 and 602. Similarly, the group name of the subject E is displayed in the region 605. The region 605 is framed with a color or style same as the color or style of the frame 603. Regions 607 and 608 in FIG. 6C are facial images of the remaining members of the group having the largest number of subjects to be photographed within the frame. In other words, the regions 607 and 608 are the facial images of the remaining members of the group to which the subjects C and D belong. The frames of the regions 607, 608, 601, 602, and 604 have a same color or style.

Thus, by referring to the photographing support data, the photographer can determine the subjects of the same group and its group name. In other words, if a subject of a different group is included in the frame, that subject can be identified according to the support information. Thus, the photographer can take the image of only the subjects of the same group by changing a composition. Further, since the rest of the members of the group of the subjects within the photographing frame are presented by the support information, if the subjects to be photographed of the same group but are not within the frame are nearby, the photographer can encourage such members to join other members and have a photograph taken together.

Although the photographing support data illustrated in FIGS. 6A to 6C is superposed on the image acquired by the photographing unit 114, the photographing support data can be presented in a different manner. For example, only the point value or the group information can be presented on the display device of the photographing apparatus 101.

The presentation of the photographing support data described above is performed each time the various subjects to be photographed are captured as images by the photographing apparatus 101 by displaying the updated frame point value, which is the evaluation result of the frame. Thus, the photographer can determine the frame to be captured while considering the combination of the subjects to be photographed by referring to the photographing support data. As described above, the photographing support data generated by the photographing support data generation unit 134 is displayed on the photographing apparatus 101.

Referring back again to FIG. 2, in step S0110, the CPU of the photographing apparatus 101 determines whether the shutter button (not shown) has been pressed. If the CPU determines that the shutter button has been pressed (YES in step S0110), the processing proceeds to step S0111. If the CPU does not determine that the shutter button has been pressed (NO in step S0110), then the processing returns to step S0102. In step S0111, the photographing processing is performed. In the course of the photographing processing, the metadata adding unit 116 adds information of the captured image to the captured image data acquired by the image data acquisition unit 115. The information of the captured image is information regarding photographing time and various conditions of photography including information of diaphragm and shutter speed. In other words, the metadata adding unit 116 adds information including the photographing time to the image data as metadata. Further, identification information, which is the information of the subject to be photographed in the frame can be extracted from the acquired photographing support data and added as metadata. When step S0111 is completed, the processing returns to step S0103. In step S0103, the data transmission unit 111 transmits the data of the photographed image and the metadata to the server 103.

When the server 103 receives the image data which has been generated by the photographing processing, the image data is processed with the processing in steps S0105 to S0107 just like the image data before the photographing processing, and processing such as point calculation is performed. When the image data that has undergone the photographing processing is processed, the transmission of the photographing support data performed in step S0107 can be omitted. In that case, the processing on and after step S0108 of the photographing apparatus 101 is also omitted. This is to eliminate overlapping processing.

In step S0112, the photographing support data generation unit 134 of the server 103 determines whether the image data is a photographed image, according to the presence/absence of the above-described metadata. If the image data is determined as captured image data (YES in step S0112), the processing proceeds to step S0113. If the image data is not determined as captured image data (NO in step S0112), the processing returns to step S0104. In step S0113, the photographing information processing unit 135 acquires the image data, the metadata, the photographing support information, and the identification information of the person in the photographed image, and stores such data in the database 104 in association with one another.

According to the present embodiment, although the subject to be photographed is a person, the subject is not limited to a person. For example, a wedding cake can be registered as the subject to be photographed at a wedding reception. In this case, reference data used for identifying the wedding cake will be registered in the condition registration apparatus 102. Then, the guests who desire to take a photograph with the wedding cake will be grouped with the wedding cake in advance and registered in the condition registration apparatus 102. When the person who desires to be photographed with the wedding cake, and the wedding cake are in the same photographing frame, the photographer is advised to perform photographing according to the point value. In this manner, the photographer will not miss a chance of taking commemorative photographs.

According to the above-described photographing support information presentation processing that takes the combination of the subjects to be photographed into consideration, the photographer can find a frame including more subjects to be photographed in the same group by referring to the point value displayed on the screen. If the point is high, the photographer recognizes that many of the subjects to be photographed of the same group are within the frame, and the photographs for the album can be taken with a high degree of efficiency.

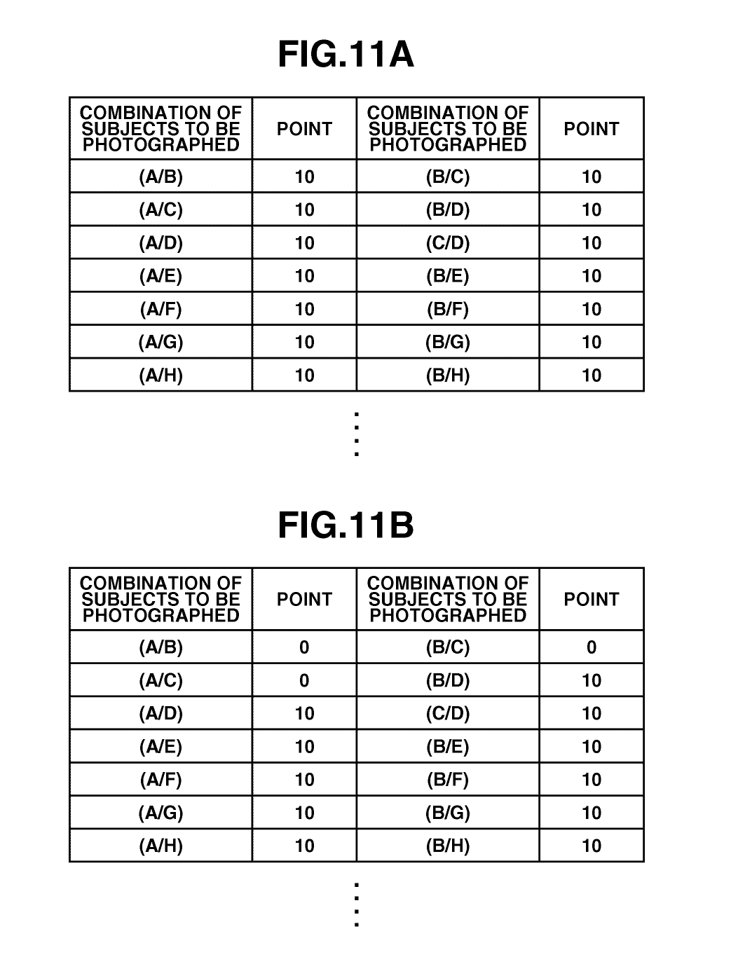

According to the present embodiment, groups are set and the photographer is assisted so that an image of the subjects to be photographed in a same group within a frame is captured. However, the combination is not limited to such a combination and photographing of various combinations of the subject to be photographed and other subject to be photographed can be supported. Examples of the subjects combination table which is used when various combinations of the photographing of the subject to be photographed and other subject to be photographed is performed is illustrated in FIGS. 11A and 11B.

FIG. 11A is the subjects combination table data before the photographing. A same point value is assigned to each combination of the subjects to be photographed. For example, the point value when the subjects A, B, and C are included in the image data will be 30 points (=10+10+10) as it will be a total of the point values of the three combinations of the combination of the subjects to be photographed (A/B), (A/C), and (B/C).

When the photographing is finished, the photographing information processing unit 135 stores the image data in the database 104 and updates the data of the subjects combination table based on the combination of the subjects to be photographed within the image which has been photographed. FIG. 11B is the subjects combination table which is updated after the photograph of the subjects A, B, and C is taken. The points for the combinations (A/B), (A/C), and (B/C) of the subjects in the image which has been captured are set to 0.

In this manner, since a point value is not assigned to the combination of the subjects whose photographing has been completed, a point value of the frame that includes the combination of the subjects which has already appeared will be low. Thus, by referring to the point value which is displayed on the screen, the photographer can perform the photographing of the subject to be photographed in combination with other subjects to be photographed. Although the point value of the combination of the subjects whose photograph has already been taken is set to 0 in the description above, the point value can be reduced in stages, for example, to 5. In this manner, support is continuously provided for a combination of the photographing-completed subjects, and a support corresponding to the number of the photographs to be taken can be provided.

Further, if a certain number of combinations regarding the photographing of a subject to be photographed with other subjects to be photographed is performed, the photographing information processing unit 135 can set the point of the photographing-completed combination to 10 again. In this manner, by assigning a point value again, for example, even if certain subjects to be photographed are always behaving together, photographing support is provided so that their photograph can be taken again.

As described above, since the photographing support regarding various combinations of the subject to be photographed and other subject to be photographed is provided, by referring to the point value, the photographer can determine whether the frame includes a photographing-completed combination in advance. For example, an album of a school trip including various combinations of students can be produced.

According to the first exemplary embodiment, photographing support regarding the combination of the subjects is provided to the photographer so that photographs appropriate for an album can be taken. According to a second exemplary embodiment of the present invention, the photographer is supported so that the photographs are not intensively taken in a particular period of time. In other words, according to the present embodiment, the evaluation condition data processing unit 136 calculates the point value according to an evaluation condition based on the time that elapsed. In the following description, points different from the first exemplary embodiment will be described in detail.

According to the present embodiment, a photographing time condition which is a point condition is also registered in the condition registration processing performed in step S0101 in FIG. 2. As is with the first exemplary embodiment, the condition registration apparatus 102 acquires the names of the people to be photographed based on the information input by the user. Then, for each subject to be photographed, a point value corresponding to the time that elapsed from the last photographing is set. The system may also be configured so that a point value that corresponds to the time that elapsed from the last photographing is assigned in advance. The condition registration unit 122 generates table data of the photographing time condition based on the point value which has been set and stores the data in the database 104. In other words, an evaluation condition of the frame according to the subject and based on the photographing time is registered.

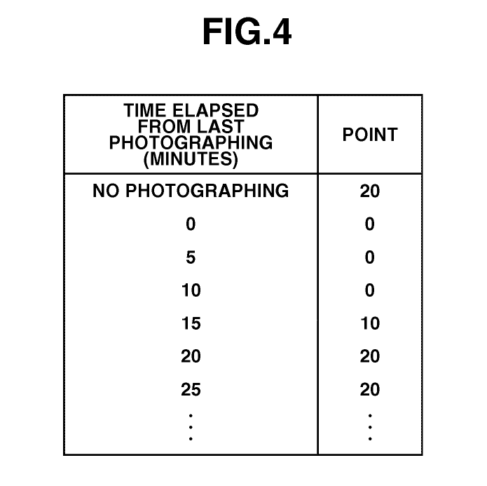

According to the photographing support system of the present embodiment, the last photographing time is managed for each subject. An example of table data of the photographing time condition registered in the condition registration processing is illustrated in FIG. 4. In the following description, table data of the photographing time condition of the subject A will be used as the table data. In FIG. 4, from 0 to less than 15 minutes after an image of the subject A is captured, the point value is set to 0. A point value is assigned to the subject A after more than 15 minutes passes. If an image of the subject A has not been captured even once, 20 points will be assigned to the subject A.

According to the point calculation processing in step S0106, the evaluation condition data processing unit 136 calculates the point value based on the photographing time condition which is the point condition. The point value is calculated according to an instruction given by the photographing support data generation unit 134. First, the evaluation condition data processing unit 136 acquires the identification information of the person in the image data. Then, the evaluation condition data processing unit 136 acquires the last photographing time of the person in the image data from the database 104. After then, based on the above-described table of the photographing time condition and the time that elapsed from the last photographing, the point value for each subject in the image data will be calculated.

The point number according to the photographing time condition of the frame is a total of the point values corresponding to each person in the image data regarding the time that elapsed from the last photographing. In other words, the whole photographing frame is evaluated based on the evaluation condition of the photographing time of each subject in the frame.

For example, if the conditions of all of the subjects are set as illustrated in FIG. 4, and if the subjects A, B, and C are in the image data, and, further, if all of them are not photographed in the past, the point value of the frame will be 60 (=20+20+20). When the photographing of the subjects A, B, and C is performed under the above-described condition, the time of the last photographing is stored in the database 104 by the photographing information processing unit 135.

Next, a case where the subjects A, B, and D are within the frame 15 minutes after the photographing of the subjects A, B, and C is performed will be described. Since 15 minutes have passed from the time of the last photographing of the subjects A and B, if the evaluation condition illustrated in FIG. 4 is used, 10 points will be assigned to each of the subjects A and B. As for the person D, 20 points will be assigned to the person D. This is because the photographing of the person D is not performed yet. Thus, the point value according to the photographing time condition which is the evaluation result of the whole photographing frame will be 40 (=10+10+20).

In this manner, the point value is set to a low value until the time that elapsed from the last photographing reaches a certain time and the point value is given only after a certain period of time has passed. By referring to the point, the photographer can determine whether to perform the photographing based on the time that elapsed from the last photographing. In other words, the photographer is supported so that images are not intensively captured within a certain period of time. Further, images of a similar composition or background taken in a short period of time can be reduced, and the photographing for the album can be efficiently performed.

Further, since the point value can be changed for each person, by assigning a high point value to, for example, a guest of honor, even if the elapsed time is short, the photographing of that person can be supported. The obtained point value is transmitted to the photographing apparatus 101 and displayed on the display unit 113 of the imaging device.

Further, a warning may be issued when a subject is included in the frame but a certain period of time has not yet passed from the last photographing. For example, the photographing support data generation unit 134 determines whether a subject whose time that elapsed from the last photographing has not exceeded a certain period of time is included in the frame when the photographing support data is generated in step S0107. Then, the photographing support data generation unit 134 adds information to the photographing support data which is useful in identifying such a subject in the frame. For example, information that allows display of a face frame of the subject is added to the photographing support data.

According to such configuration, the photographer can easily determine the subject to be photographed whose time that elapsed from the last photographing has not exceeded a certain period of time. In other words, since the photographer can easily take photographs by excluding such a subject, images are not intensively captured within a certain period of time.

Further, when the photographing is performed, in step S0113, the photographing time recorded in the metadata is associated with the information of the captured person by the photographing information processing unit 135 and stored in the database 104. This information is used when the point value of the photographing time condition described above is calculated.

Further, the system may be configured so that the reduction in the point value according to time passage does not occur if photographs not appropriate for the album are taken. As a photograph appropriate for an album, for example, the subject who is smiling is desirable.

Thus, the degree of smile of the subject in the captured image is measured and the photographing time when the degree of smile has been greater than a reference value, is set as the reference point used for measuring the time that elapsed. In other words, in step S0106 in FIG. 2, the evaluation condition data processing unit 136 references the degree of smile of the image of the identified subject which has been captured the last time and which is stored in the database 104. Then, the evaluation condition data processing unit 136 determines whether the degree of smile is lower than a reference value.

If the evaluation condition data processing unit 136 determines that the degree of smile is lower than the reference value, then the evaluation condition data processing unit 136 references a point value of the degree of smile of a photograph which has been taken just prior to that photograph. In this manner, a photograph that can be used as the reference point of the time that elapsed from the photographing is identified. Then, by using the photographing time of the photograph whose degree of smile is greater than the reference value as the reference point, the point value corresponding to the time that elapsed from the photographing of each subject can be calculated.

Further, with respect to the photographed image, in step S0105, the image analyzing unit 133 identifies each subject in the image data and measures the degree of smile. Since the degree of smile is measured nowadays by various practical techniques, details of such techniques are not described. In step S0113, the photographing information processing unit 135 stores in the database 104 the degree of smile in association with the photographing time for each subject.

According to such configuration, if an image of a person who is not smiling is captured, the point value is not reduced according to elapsed time. Thus, until a smile appropriate for the album is captured, the photographer is given the photographing support by the frame point value.

The condition of the frame is not limited to a smile. For example, in place of the degree of smile of the subject, whether the eyes of the subject are closed or whether the subject is facing front may be used as the condition. If such a condition is used in the photographing support in a manner described above, reduction in the point value according to the elapsed time based on a miss-shot of the subject closing the eyes can be prevented and support of higher quality can be provided. Further, the photographer can capture more images of the subject facing the front.

As for the method for measuring the degree of smile of the subject to be photographed, JP2009-163422, for example, discusses such a method. As for the detection of face orientation, a method discussed in “Identifying Image of Figure—Computer Vision For Human Interface”, Suenaga, IEICE (The Institute of Electronics, Information and Communication Engineers) Transactions, pp. 800-804, 1995/8 can be used. As for the method for detecting whether the eyes of the subject are closed, a method discussed in JP2009-296165 can be used.

In this manner, only the photographs appropriate for producing an album are taken and the photographs are not intensively taken in a particular period of time. Thus, photographing support useful in realizing efficient photographing necessary in producing an album can be performed.

As described above, according to the present embodiment, since the photographing support that prevents the photographer from intensively taking photographs in a particular period of time is performed, an evaluation result indicating whether to capture the currently-captured frame or not can be presented to the photographer. Further, if various events are held in one day, the photographer can evenly capture the images of the guests at each event.

Further, even if the schedule of the event is changed or delayed, since the photographing support is performed according to the photographing time that has elapsed, the photographing support can be provided in a balanced manner for each event. Thus, the photographing time is considered for each subject and an album including photographs of each event taken in a balanced manner can be easily produced.

According to the first exemplary embodiment, the combination point value can be set in a changeable manner according to the importance level of the combination of the subjects to be photographed. According to a third exemplary embodiment of the present invention, the importance level is set for each individual subject. Further, the importance level is set to the schedule of the event to be photographed. In other words, according to the present embodiment, the evaluation condition data processing unit 136 evaluates the whole photographing frame according to the evaluation condition based on the importance level of the subject and the photographing time corresponding to the subject. The difference between the first exemplary embodiment and the present embodiment will be described below in detail.

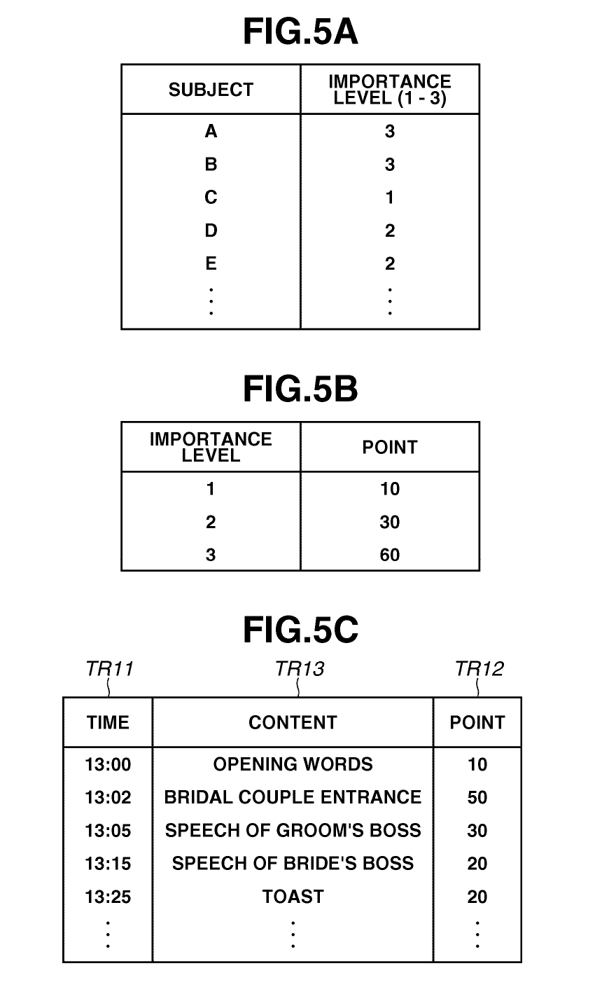

First, the registration processing of the photographing condition of the subject to be photographed illustrated in step S0101 in the flowchart in FIG. 2 according to the present embodiment will be described. The condition registration apparatus 102 instructs the user to input all the persons that can be the subjects to be photographed, the importance level of each person (1 to 3), the time schedule of each person, or the importance level of the schedule. Then, registration data is generated based on the input information. FIGS. 5A to 5C are examples of the data which has been registered according to the present embodiment. FIG. 5A illustrates an importance level of each subject. FIG. 5B illustrates a point value corresponding to the importance level.

The point value corresponding to the importance level is determined in advance or set by the user. If a high importance level is set for a person, the point value of the frame including that person will be high. Thus, for example, when the importance level of an important person, such as a guest of honor, is set to a high level, if the frame includes that important person, the photographer will be provided a positive photographing support.

FIG. 5C illustrates an example of photographing time condition data of a subject to be photographed. Time condition TR11 includes information regarding time an image of the subject should be captured. Content of the event TR13 presents each program of the event. A point value TR12 is the point value corresponding to the program. The user sets appropriate time for the photographing considering the time schedule which has been determined in advance. For example, if the event is a wedding ceremony, a photograph of the groom should be taken at timing of the bridal couple entrance. Since the scene of the bridal couple entrance is important, the point value of the time of that scene is set to a high value. In this manner, the time of the important scene is registered for each person. Thus, as illustrated in FIG. 5C, the photographing time condition data is generated for each subject to be photographed. As described above, the data of the photographing condition of the subject to be photographed as well as the photographing time condition data is registered in the database 104 as an evaluation condition for the subject.

Next, the photographing support data generation processing according to the present embodiment will be described. In step S0106 of the flowchart in FIG. 2, the evaluation condition data processing unit 136 calculates the point value based on the information of the person identified in the frame and the point values that correspond to the importance level of the subject in FIGS. 5A and 5B. Further, the evaluation condition data processing unit 136 calculates the point value based on the photographing time condition data illustrated in FIG. 5C for each subject in the frame. Further, the photographing support data generation unit 134 calculates the frame point value from the point values of the photographing condition of the subject to be photographed and the photographing time condition.

The frame point value is obtained according to:

Number of frame points=Σ(point number of the subject to be photographed in the frame) (1)

The number of the frame points is a total of the point values of all the persons within the frame. Further, the point value of each person is obtained from the equation (2) below.

$$Point number of subject A = 100 \times \{ \begin{matrix}\frac{( \begin{matrix}Point number of subject A according to \\ photographing condition of subject A\end{matrix} )}{( \begin{matrix}Maximum point number \\ according to photographing condition\end{matrix} )} \times w 1 + \\ \frac{( \begin{matrix}Point number of subject A according to \\ photographing time condition of subject A\end{matrix} )}{( \begin{matrix}Maximum point number according \\ to photographing time condition\end{matrix} )} \times w 2\end{matrix} \} \qquad ( 2 )$$

where w1 and w2 are weighting factors.

In the example described below, the point of the subject A is calculated. The “point number according to photographing condition” is a point value corresponding to the importance level of the subject to be photographed calculated by the evaluation condition data processing unit 136 and illustrated in FIG. 5B. The “point number according to photographing time condition” is a point value corresponding to the importance level of the photographing time for each subject to be photographed, calculated by the evaluation condition data processing unit 136 and illustrated in FIG. 5C.

In the equation (2), w1 and w2 are weighting factors and are numerical values which are determined according to the importance level of the subject to be photographed or the importance level of the photographing time, in other words, which are determined depending on weighting of both importance levels. The user is requested to set the weighting factors when the condition registration processing is performed by the condition registration apparatus 102. According to this weighting factor, whether to prioritize the importance level of the person or the importance level of the photographing time is determined according to the user's preference or the content of the event. Accordingly, appropriate photographing support for the scene can be provided to the photographer.

Next, an example of how a frame point value is calculated will be described. Using the items illustrated in FIGS. 5A to 5C, a case where the point value of the frame of the groom (the subject A) is calculated when a boss of the groom gives a speech, will be described. The weighting factor is set to w1=w2=1. According to FIG. 5B, the “maximum point number of the subject to be photographed” is 60 for the importance level 3. Further, as illustrated in FIG. 5A, the importance level of the subject A is set to 3.

The maximum point value set for the wedding reception is assumed to be 50 for the “bridal couple entrance” at time 13:02 illustrated in FIG. 5C. The point value for the subject A for the “speech of the groom's boss” starting from time 13:05 is 30. When the above-described values are applied to the equation (2), 160 is obtained (100×(60/60×1+30/50×1)=160). This calculation is performed by the photographing support data generation unit 134.

The above example is a case where only the groom (the subject A) is in the frame. However, for example, if the bride (the subject B) is also in the frame, according to the equation (1), the point value of the bride is also calculated. Thus, a total value of the points of the groom and the bride will be the frame point value.

In this manner, by adding the point values of all the subjects to be photographed in the frame, one point value for the frame is calculated and the evaluation of the whole photographing frame is determined. Thus, whether the scene is to be captured considering all the subjects to be photographed in the frame or whether the subject is a person to be photographed are reflected to the frame point value. In other words, the photographer can easily determine whether to perform photographing with the current composition by only referring to the frame point value.

Further, the photographing support data generation unit 134 can generate the photographing support data including information of the subject which is not yet photographed although the importance level is high, based on the current time and the photographing time condition data. For example, the photographing support data generation unit 134 refers to the photographing time condition data of the subject and grasps the subject and the photographing time whose importance levels are greater than a certain level. Such a reference importance level can be set by the user but can also be set by the system in advance. For example, the reference importance level can be set as 50% of the maximum value of importance or greater by the system.

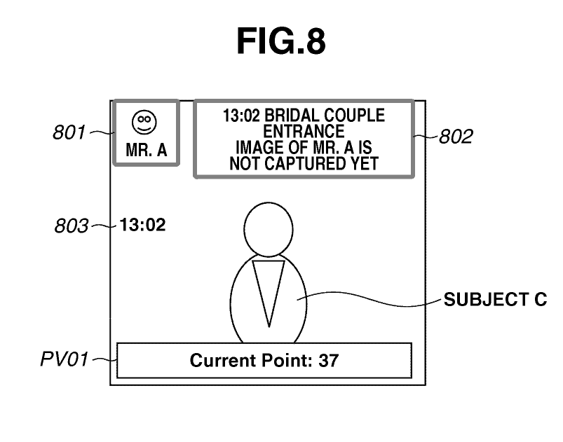

Referring to FIG. 5C, since the photograph of the groom (subject A) at the “bridal couple entrance” is extremely important, the importance level of warning is set to 50. If the photographing of the groom (subject A) is not performed (or if the subject A is not in the frame) at time 13:02, the photographing support data generation unit 134 generates a warning. The warning includes the name and the facial image of the groom and a message informing that the photographing of the groom is not performed yet. Then, the server 103 outputs the warning to the photographing apparatus 101, and the display unit 113 of the photographing apparatus 101 displays the warning. An example of the warning and how it is presented is illustrated in FIG. 8.

In FIG. 8, the frame point value of the subject C currently in the frame is displayed in the region PV01. If the importance level of the subject C is 1 and the importance of time 13:02 is 10 points, the frame point value of this frame will be “37” from the equation (2).

A region 801 is where a name and a facial image of a subject to be photographed whose photographing has not been performed yet although the importance is set to a high level are displayed. The facial image is the reference image stored in the database 104. A region 802 is where the time concerning the subject to be photographed whose photographing is not performed yet and whose importance level is higher than a certain level as well as a warning message is displayed. The time information is acquired from the database 104 in association with the photographing time condition data illustrated in FIG. 5C. The warning message is a message informing the photographer that the photographing is not performed yet. The current time is displayed in a region 803. In this manner, the photographer is given a warning since the subject A with the maximum point number for the time condition is not included in the frame at time 13:02. Thus, the photographer is reminded to capture the image of the important scene and the possibility of not capturing such a scene will be reduced.

Although the schedule is registered for each subject to be photographed in the description above, the schedule can be registered in group units by the condition registration apparatus 102. This is because the importance levels of the schedule and time of the subjects in the same group are mostly similar. Further, if the schedule can be set by the group, it will help reduce the user's time and effort in inputting the subjects for each schedule. Furthermore, when the importance level of time of a certain group is high, photographing of the members of the same group is to be supported as described in the first exemplary embodiment. Thus, based on the importance of the schedule of the group, the data of the subjects combination table, which is illustrated in FIG. 3A, is updated according to time.

In other words, the photographing information processing unit 135 changes the total point of a group to a higher value for the time period important for that group. According to such a configuration, information is presented to the photographer at the important time for the group.

The point value of each person to be photographed can be calculated by multiplying the point number based on the photographing condition of the subject to be photographed by the point number based on the photographing time condition. In this case, since a high point is obtained regarding an important scene of an important subject, the photographer is given enhanced support regarding the photographing of the current frame of the photographing apparatus.

As described above, according to the present embodiment, the evaluation of the whole frame is performed by the evaluation condition for each subject to be photographed based on the importance level of the subject to be photographed and the photographing time. Thus, information considering the person to be photographed and time can be presented to the photographer. Further, since an importance level is set for the subject to be photographed, the photographer is encouraged to take photographs of, for example, a guest of honor compared to ordinary subjects. Further, since an importance level is set for the photographing time, photographing of a scene at the time an image should be captured is supported.

According to a fourth exemplary embodiment of the present invention, a combination of support of the above-described exemplary embodiments will be described. In other words, according to the present embodiment, the support based on the combination of the subjects to be photographed and the support based on the importance level are combined. Further, according to the above-described exemplary embodiments, a frame point value which is the evaluation result is obtained by adding the point value of each subject to be photographed. However, if a great number of people are registered as the subjects to be photographed, and further, if a large number of people are within a frame, a high point value will be obtained, and appropriate photographing support may not be provided. Thus, according to the present embodiment, the maximum frame point value is determined and the user can determine whether to perform the photographing in a quantitative manner.

Now, photographing support data presentation processing according to the present embodiment will be described with reference to the flowchart illustrated in FIG. 12.

In step S0201, the condition registration apparatus 102 registers the evaluation condition. Since the condition registration processing is described in the embodiments described above with reference to step S0101 in FIG. 2, the description of the condition registration processing is not repeated. In step S0202, the CPU of the photographing apparatus 101 determines whether the power of the imaging device is turned on. If the power is turned on (YES in step S0202), the processing proceeds to step S0203. If the power is not turned on (NO in step S0202), the processing ends. In step S0203, the data transmission unit 111 transmits reduced image data to the server 103.

The reduced image data is image data whose size is smaller than the image acquired by the photographing processing. The reduced image data is generated by the image data acquisition unit 115 performing reduction processing of the acquired image data. By transmitting the image data of a reduced photographing frame to the server 103, the processing load of the server 103 and the communication traffic can be reduced. This contributes to realizing real-time acquisition of the photographing support data of the photographing apparatus 101.

In step S0204, the CPU of the server 103 determines whether the server 103 has acquired the image data from the photographing apparatus 101. If the image data has been acquired (YES in step S0204), the processing proceeds to step S0205. If the image data has not been acquired yet (NO in step S0204), then the processing ends. In step S0205, the server 103 determines whether the image data acquired from the photographing apparatus 101 is a photographed image according to the image size. If the image data is not a photographed image (NO in step S0205), the processing proceeds to step S0206. In step S0206, the image analyzing unit 133 analyzes the received image data (frame), performs processing such as face detection or face recognition, and identifies the subject to be photographed within the photographing frame.

In step S0207, based on the result of the face detection performed by the image analyzing unit 133, the server 103 determines the number of the subject. If a plurality of subjects are included (NO in step S0207), the processing proceeds to step S0208. In step S0208, the evaluation condition data processing unit 136 calculates the point value regarding the combination of the subjects to be photographed according to the group information of the photographing condition of the subject to be photographed. Points different from the first exemplary embodiment will now be described in detail.

The equation (3) below is a calculating formula used for finding the number of the frame point based on a combination of subjects according to the present embodiment.

Frame point number(combination)={number of combinations of the same group/number of all combinations NC2×100 (3)

where N is the number of subjects in a frame.

According to the equation (3), if all the members of a group are within a frame and the frame does not include members of other groups, the point number will be 100, which is the maximum possible score. Thus, the photographer can easily determine whether to perform the photographing of the frame based on a quantitative numerical value according to whether the point is close to 100. For example, messages such as “photographing is not necessary” are displayed for 0 to 30 points, “photographing is not particularly recommended” is displayed for 30 to 60 points, and “photographing is strongly recommended” is displayed for 60 to 100 points. Thus, the photographer is given explicit support.

Next, a point value when the subjects A, B, and E are included in the image data based on the group information illustrated in FIG. 3B will be described. The number of the subjects in the frame is three (N=3). Thus, the number of the combinations can be obtained by ₃C₂, and the number of combinations is three ((A/B), (A/E), and (B/E)). Further, the number of combinations of the same group is one (A/B) from the group information in FIG. 3B. In this case, the frame point value based on the group information is 33 (=1/3×100) according to the equation (3). Thus, the photographer can determine that the photographing of the frame is not necessary by referring to the point value.

Such support is given since if one subject out of the three subjects belong to a different group, the subject A and the subject E or the subject B and the subject E may not know each other. Since an album including photographs of strangers is not welcome, the demand for such an album is reduced. According to the photographing support system of the present embodiment, however, photographing support useful for obtaining photographs appropriate for the album can be provided. As described above, the frame can be evaluated based on the group information.

In step S0209, the point is calculated based on the importance level. The number of frame points according to the importance level is obtained by the calculating formula of the equation (4).

Number of frame points(importance level)=(point number for one subject to be photographed×w₁+point number for two subjects to be photographed×w₂ . . . point number for number N subjects to be photographed×w_{N}) (4)

where w₁, w₂ . . . w_{N}:weighting factor (w₁+w₂+ . . . w_{N}=1) and N is the number of subjects in the frame.

The point for each subject is obtained according to the calculating formula (5) below.

$$Number of points of subject A = 100 \times \{ \frac{\begin{matrix}( \begin{matrix}Point number of subject A according to \\ photographing condition of subject A\end{matrix} ) \times \\ ( \begin{matrix}Point number of subject A according to \\ photographing time condition of subject A\end{matrix} )\end{matrix}}{\begin{matrix}( \begin{matrix}Maximum point number according to \\ photographing condition\end{matrix} ) \times \\ ( \begin{matrix}Maximum point number according to \\ photographing time condition\end{matrix} )\end{matrix}} \} \qquad ( 5 )$$

Further, the process of finding the weighting factor according to the equation (5) will be described. According to the weighting factor, the subject that should be weighted in calculating the point number of the frame can be determined. As an example of the determination of the weighting factor, greater weighting is applied to a person in a position closer to the center of the image, and the weighting factor is determined according to the importance level of the subject illustrated in FIG. 5A corresponding to the person in the frame. As an example of a calculating formula used for finding the weighting factor according to the importance level of the subject, the calculating formula (6) below will be used.

Weighting factor WX=importance level of subject to be photographed×/Σₙ₌₁^{N} importance level of subject to be photographed n (6)

N: the number of objects in the frame

For example, suppose three people are in a frame. A first subject is a person of the importance level 3, a second subject is a person of the importance level 2, and a third subject is a person of the importance level 1. The weighting factor w₁ of the first subject whose importance level is 3 will be ½ (3/(3+2+1)) from the equation (6). Similarly, the weighting factor w₂ of the second subject whose importance level is importance 2 is ⅓ (2/(3+2+1). Further, the weighting factor w₃ of the third subject whose importance level is 1 is ⅙ (1/(3+2+1). In this manner, the weighting factor of each subject is calculated by the photographing support data generation unit 134. As described above, since the weighting factor is determined for each subject in the frame, points of important persons are reflected to the frame point value.

As described above, the weighting factor in the equation (6) is determined by the photographing support data generation unit 134, the frame point number considering the importance level is calculated, and the frame is evaluated. Thus, the photographer can determine whether to perform the photographing of the frame based on a quantitative reference value, according to whether the point is close to 100 or not. Further, with respect to the frame point value, for example, the point value of a subject closer to the center of the frame or a person of high importance level can be additionally reflected to the frame point value. Thus, by referring to the point value, the photographer can easily recognize whether the scene is an important scene including an important person even if many subjects are included in the frame.

Next, the point value calculation when the subject is one person will be described. In step S0207, if the server 103 determines that the subject is one person (YES in step S0207), the processing proceeds to step S0210. In step S0210, a point value is calculated according to the importance level. The point value is calculated by using the equation (5).

In step S0211, the point value is calculated based on a photographic image condition which is the point condition. The photographic image condition is a condition used for determining whether the composition of the photograph to be taken is appropriate for use of the album. The composition of an image is, for example, face position, face orientation, face size, facial expression, or focus position of the subject of the image. When an album is produced using photographs of people, it is preferable if photographs of various compositions are included. This is because if all the photographs have a similar composition, such as faces at the center of the image, the produced album will be monotonous.

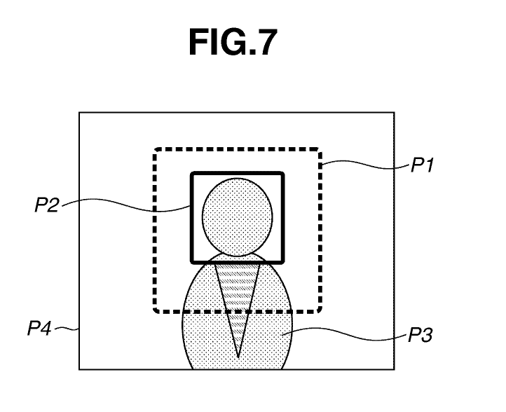

FIG. 7 illustrates an example of a photograph of a human figure. In taking a photograph P4 of a human figure P3, it is desirable not to have too many photographs with a same position such as a face position P2 in an area Plat the central area. Thus, as the photographic image condition, a defined region Pct, which is region information of the area P1 illustrated in FIG. 7, is registered as a defined region. Further, an upper limit of the number of photographs to be taken is set as an upper limit Np1. These values can be input by the user. However, an appropriate value can be prepared by the system in advance and registered in the database.

In step S0211, the evaluation condition data processing unit 136 acquires a face region Pf indicating a face position of the subject to be photographed from the image analyzing unit 133. Then, the evaluation condition data processing unit 136 determines whether the face region Pf of the face of the subject is in the defined region Pc1 of the area P1 which has been registered. If the face region Pf is included in the defined region Pc1, out of the captured images including the subject and stored in the database 104, the number of images (captured images) having the face area included in the defined region Pc1 is counted. According to the present embodiment, information of the number of the captured images and information regarding which portion of the image includes the face region is managed for each subject to be photographed. Then, the point value is calculated based on the number of the photographs that are taken whose face region is included in the defined region Pc1 of the area P1.

Next, calculation of the point when photographing in a defined region is supported until the number of photographs that are taken reaches the upper limit Np1 and photographing in a region other than the defined region is supported after the number of photographs that are taken exceeds the upper limit Np1 will be described. If the face region Pf is within the defined region Pct, the point value is set to 100 until the number of the photographs that are taken reaches half of the upper limit Np1 and then the photographing is instructed. On the other hand, if the face region Pf is out of the defined region Pct, the point value is set to 0 until the number of the photographs that are taken reaches half of the upper limit Np1. In other words, until the number of the photographs that are taken reaches a certain number, the composition having the face included in the defined region Pc1 is supported. Further, the point number when the face region Pf is included in the defined region Pc1 is reduced corresponding to the number of the photographs that are taken from when the number of the photographs having the face area included in the defined region Pc1 exceeds half of the upper limit Np1 to when it reaches the upper limit Np1.

Further, the point number in a case the face region Pf is out of the defined region Pc1 is increased corresponding to the number of the photographs that are taken. After the number of the photographs that are taken reaches the upper limit Np1, the point number will be 0 if the face region Pf is in the defined region Pc1. Further, the point number will be 100 if the face region Pf is out of the defined region Pc1. As a result, since the photographer can determine the images to be taken according to high point numbers, photographs of various compositions can be taken. Thus, an attractive album can be produced.

As described above, the point is calculated and the evaluation is performed based on the photographic image condition which is the evaluation condition corresponding to the subject of the photographing information of the past. The photographic image condition is not limited to the example described above and, for example, the point can be calculated according to a distance between the defined region Pc1 and the face region Pf. Further, the point can be calculated according to the degree of smile, the face orientation, or whether the subject's eyes are shut. By referencing the point value, the photographer can easily determine the smile and the face orientation of the subject. Furthermore, the point can be obtained according to the ratio of the face area with respect to the image area or whether focusing is obtained.

In step S0212, the photographing support data generation unit 134 generates the photographing support data which can be displayed on the imaging device by using the frame point value which is the evaluation result of the whole photographing frame. Then, the data transmission unit 131 outputs the photographing support data to the photographing apparatus 101.

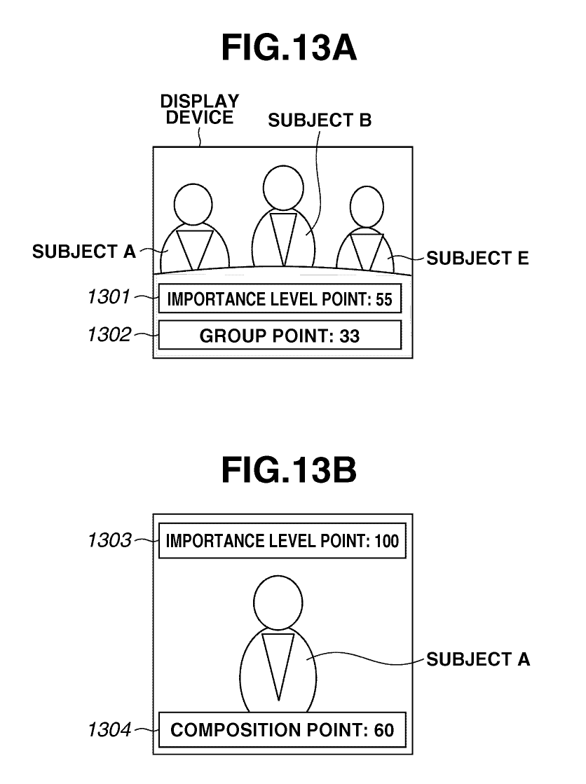

In step S0213, the photographing apparatus 101 determines whether the photographing support data is acquired. If the photographing support data is acquired (YES in step S0213), the processing proceeds to step S0214. If the photographing support data is not acquired (NO in step S0213), step S0213 is repeated. In step S0214, the display unit 113 displays the acquired photographing support data on the display device. Presentation examples of the photographing support data according to the present embodiment are illustrated in FIGS. 13A and 13B. FIG. 13A is a case where the subjects A, B, and E are in the frame. A point value related to the importance level is displayed in a region 1301 and a point value related to group information is displayed in a region 1302. FIG. 13B is a case where the subject A alone is in the frame. A point value related to the importance level is displayed in a region 1303 and a point value related to configuration is displayed in a region 1304. Since the photographing support information is changed according to the number of the subjects, photographing support according to the state of the subject can be performed.

In step S0215, the photographing apparatus 101 determines whether the shutter button is pressed. If the shutter button is pressed (YES in step S0215), the processing proceeds to step S0216. If the shutter button is not pressed (NO in step S0215), the processing returns to step S0202. In step S0216, the photographing processing is performed. In the course of the photographing processing, the metadata adding unit 116 adds the image information of the captured image and the received photographing support data to the captured image data acquired by the image data acquisition unit 115 as metadata. This is to reduce the processing load of the server 103 by preventing the server 103 from re-calculating the point value of the captured image.

In step S0217, the data transmission unit 111 transmits the captured image data with the metadata to the server 103, and the processing proceeds to step S0204. In step S0205, if the server 103 determines that the image data is data of a photographed image according to the image size and the presence/absence of the metadata (YES in step S0205), the processing proceeds to step S0218. In step S0218, the captured image data, the metadata, and the identification information is stored in association with one another.

As described above, according to the present embodiment, by quantitatively using the point, the photographer can explicitly determine whether to perform photographing of the frame. Further, since the evaluation results which can be used for determining whether to perform the photographing of the frame from a plurality of viewpoints are separately presented, the photographer can determine whether to perform photographing of the frame according to the intent of the photographing operation. Further, appropriate photographing support can be provided since the support data is changed according to the number of the subjects.

According to the present embodiment, although the photographing support based on the photographic image condition is provided when the subject is one person, support based on the photographic image condition can also be provided when a plurality of subjects are included in the frame. For example, the point number according to the photographic image condition can be used when the point number for each subject is calculated according to the equations (2) and (5).

Further, although the photographing support is performed by changing the combination of the subjects, the importance level, and the composition, the point number of the whole frame can be calculated from a point value of one frame according to:

Frame point number=(point number of the frame according to the photographing condition of the subject to be photographed)+(the point number of the frame according to the photographing time condition). According to such a configuration, the photographer can easily determine whether to perform the photographing by a glance of the point value. This is because photographing support including a plurality of factors is presented by the frame point value.

According to the exemplary embodiments described above, the frame point value is presented to the photographer. According to a fifth exemplary embodiment of the present invention, the evaluation information is presented to the photographer in an easy-to-understand manner. In other words, in place of the frame point value, a text message or an icon will be presented.

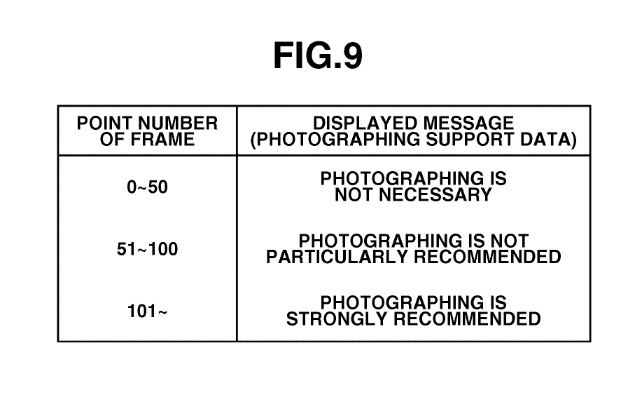

For example, as illustrated in FIG. 9, three types of character strings are set for three stages that correspond to the frame point values. The character strings are stored in the database 104. When the photographing support data generation unit 134 generates the photographing support data, the photographing support data generation unit 134 uses the character string set as the photographing support data according to the frame point value. The character string is transmitted to the photographing apparatus 101 and displayed on the display device. In place of the character string, an icon that corresponds to the character string can be also used.

According to the present embodiment, the evaluation result of the frame is presented to the photographer by a character string or an icon. Thus the photographer can intuitively determine whether to capture the image. Thus, photographs for the album can be taken more efficiently.

According to a sixth exemplary embodiment of the present invention, when the user registers each of the various conditions, such as the photographing condition of the subject described in step S0101 in FIG. 2 in the above-described exemplary embodiments, support that allows easier setting of the items according to the objective of the user is provided to the user.

A case where a photograph of members of a same group is taken is described, for example, in the first exemplary embodiment and a case where a photograph of a person of a high importance level is taken is described in the third exemplary embodiment. In such cases, the user needs to set a parameter corresponding to the objective such as “non-serial photographs taken in a short period of time”, “photographs of members of a same group”, or “photographs of a person of a high importance level” by using the setting screen.

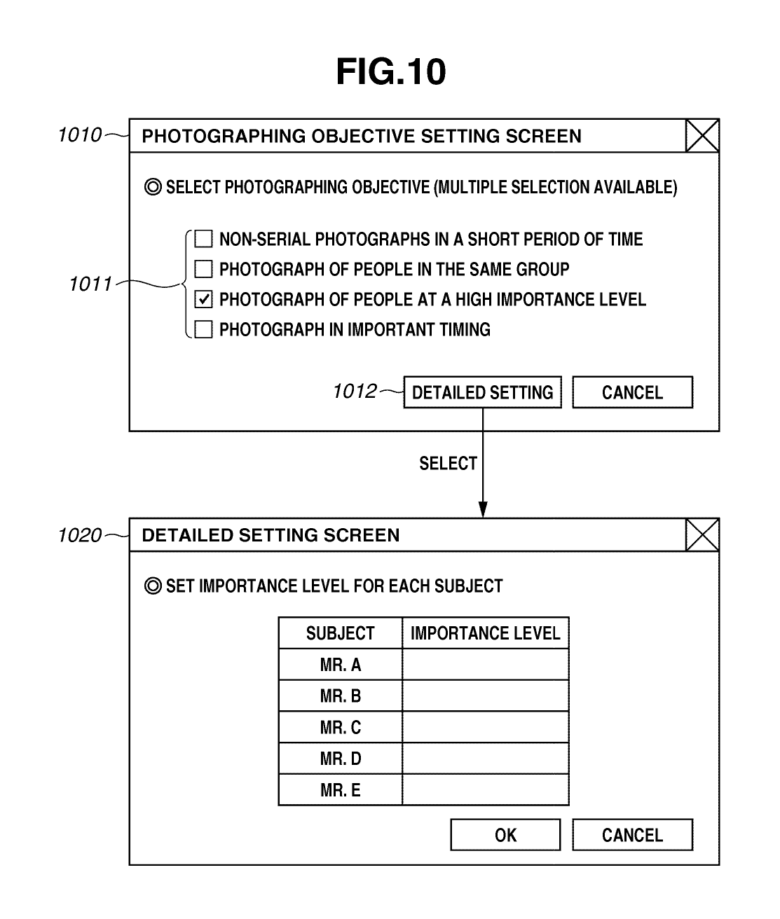

According to the present embodiment, the objectives of the photographing are prepared in advance in a form of a list. An example of the setting screen displayed on the display device of the condition registration apparatus 102 will be illustrated in FIG. 10. A photographing objective setting screen 1010 displays a list of photographing objective setting items 1011. If the user selects an item from the list, a detailed setting screen 1020 is displayed. A parameter item corresponding to the objective is displayed on the screen.

Further, if a default value of each parameter item is set on the system, a default value can be set by the user by only selecting an item from the objective list. Further, if a pull-down menu is provided on the UI, the user can easily make the selection.

As described above, the user can use the photographing support system more easily by selecting the type of photographing support.

Further, although an objective of the photographing is listed and the parameter corresponding to the objective is set in the above description, the user can also select an event scene and set the parameter item for that scene. For example, if a list of scenes such as a “wedding ceremony”, a “school trip”, and a “trip with a friend” are displayed on the display device of the condition registration apparatus 102, the user can select an item by using an input device such as a mouse.

For example, if the “wedding ceremony” is selected, subjects which are considered to be the subjects to be photographed such as the groom, the bride, the groom's father, and the groom's boss are registered. Thus, even if the user does not register the groups, such as the “groom's family” and the “bride's family” described in the first exemplary embodiment, the system can perform the operation. Accordingly, even if the photographer does not know the face of the subjects, photographing support is provided by the system so that, for example, the family members are more frequently included in the same frame.

The present invention can be realized, for example, by a system, an apparatus, a method, a program, or a recording medium (storage medium). To be more precise, the present invention can be realized by a system including a plurality of apparatuses (e.g., a host computer, an interface apparatus, an imaging device, or a web application).

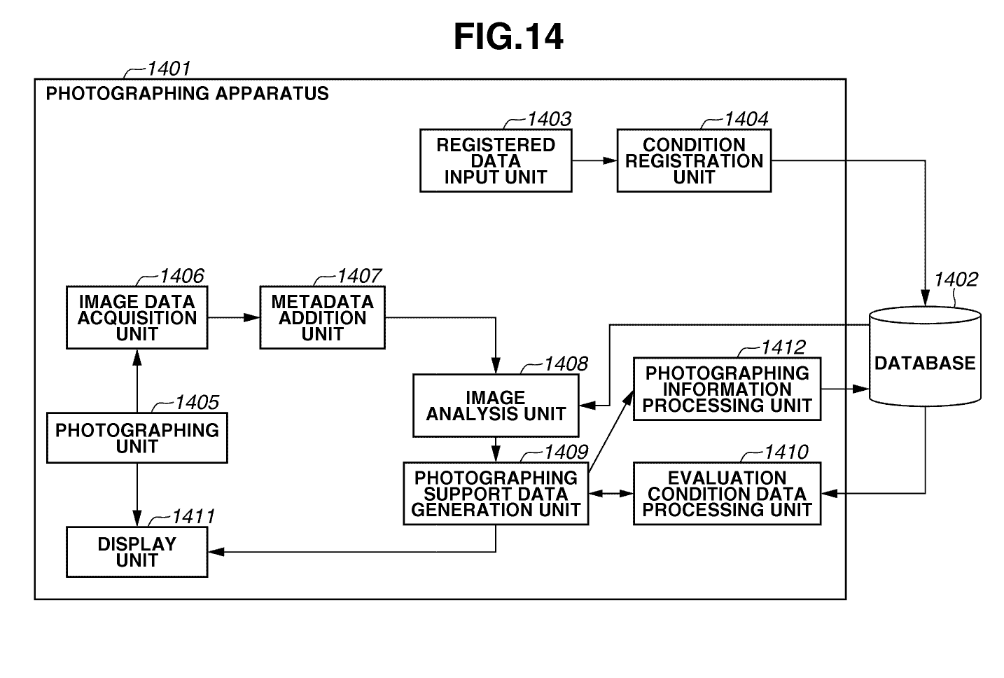

Further, the photographing support system described in each of the exemplary embodiments can be realized by a single photographing apparatus. FIG. 14 is a block diagram of such a photographing apparatus which can provide the photographing support. A photographing apparatus 1401 includes a database 1402, which is realized by a built-in or a removable storage unit. The support data generation processing, which is processing performed by the server 103, is realized by a control device such as a CPU of the photographing apparatus 1401 and a program used for generating support data.

In operating the photographing apparatus 1401 in FIG. 14, the photographer inputs the subject to be photographed and the evaluation condition by using a registration data input unit 1403 which is an input device such as a button of the photographing apparatus. Then, a condition registration unit 1404 registers a reference image of the person to be photographed and an evaluation condition in the database 1402. An image analyzing unit 1408 analyzes the photographing frame acquired by a photographing unit 1405 and an image data acquisition unit 1406. A photographing support data generation unit 1409 transmits the result of the image analysis to an evaluation condition data processing unit 1410 and instructs the evaluation condition data processing unit 1410 to evaluate the photographing frame.

The evaluation condition data processing unit 1410 evaluates the photographing frame based on the evaluation condition and the result of the image analysis. Then, the photographing support data generation unit 1409 generates photographing support data by using the evaluation result of the photographing frame. A display unit 1411 superposes the generated photographing support data on the photographing frame, displays and presents it to the photographer. Further, if the photographing processing is performed, a metadata adding unit 1407 adds metadata to the photographing frame. Then, the captured frame (captured image) is stored in the database 1402 by a photographing information processing unit 1412. Thus, the photographing support described in each of the exemplary embodiments described above can be executed by a single photographing apparatus.

Further, the above-described exemplary embodiments can also be achieved by supplying a software program that realizes each function of aforementioned exemplary embodiments to a system or an apparatus via a network or various types of storage media, and a computer (or a CPU or a MPU) in the system or the apparatus reads and executes the program stored in such storage media.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium)

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-159009 filed Jul. 13, 2010, which is hereby incorporated by reference herein in its entirety.

What is claimed is:

1. A photographing support system configured to support photographing performed by a photographing apparatus, the system comprising:
an identification unit configured to identify an object within a photographing frame;
an evaluation unit configured to evaluate a whole photographing frame based on an evaluation condition set for each object within the photographing frame which has been identified; and
a presentation unit configured to present an evaluation result of the evaluation unit to a photographer as support information.

2. The photographing support system according to claim 1, wherein the evaluation condition includes a condition which is changed according to a combination of objects.

3. The photographing support system according to claim 1, wherein the evaluation condition includes a condition of a group to which the object belongs, and
wherein if a combination of objects set as a same group is within the photographing frame, the evaluation unit gives a lower rate to the photographing frame compared to when a combination of objects set as a same group is not within the photographing frame.

4. The photographing support system according to claim. 1, wherein the evaluation condition is a condition of a group to which the object belongs, and
the evaluation unit gives a higher rate to combination of objects of a same group compared to a combination of objects set as a different group.

5. The photographing support system according to claim. 1, wherein the presentation unit further presents group information of a group of the objects within the photographing frame.

6. The photographing support system according to claim 1, wherein if an object of a different group is included in a plurality of objects within the photographing frame, the presentation unit presents information which can be used in identifying the object of the different group.

7. The photographing support system according to claim 1, wherein the evaluation unit gives a lower rate to a photographing-completed object or a combination of photographing-completed objects compared to a non-photographing-completed object or a combination of non-photographing-completed objects.

8. The photographing support system according to claim 1, wherein the evaluation condition includes an importance level of the object.

9. The photographing support system according to claim 1, wherein the evaluation condition includes a condition which is changed according to photographing time.

10. The photographing support system according to claim 1, wherein the evaluation condition includes information used for evaluation based on time elapsed from when the object has been photographed.

11. The photographing support system according to claim 1, wherein the evaluation condition includes a condition indicating time at which the object is to be photographed.

12. The photographing support system according to claim 11, further comprising a warning unit configured to warn a photographer when the object to be photographed is not within the photographing frame at the time the object is to be photographed.

13. The photographing support system according to claim 1, wherein the evaluation condition includes a condition corresponding to a composition of the photographing frame.

14. The photographing support system according to claim 1, wherein the evaluation unit evaluates the whole photographing frame by calculating a point of the whole photographing frame based on the evaluation condition set for each identified object within the photographing frame.

15. The photographing support system according to claim 1, further comprising a registration unit configured to register the object and the evaluation condition.

16. A photographing support method for supporting photographing performed by a photographing apparatus, the method comprising:
identifying an object within a photographing frame;
evaluating a whole photographing frame based on an evaluation condition set for each object within the photographing frame which has been identified; and
presenting an evaluation result of the evaluation to a photographer as support information.

17. A server for outputting support information used for supporting photographing performed by a photographing apparatus to the photographing apparatus, the server comprising:
an acquisition unit configured to acquire a photographing frame;
an identification unit configured to identify an object within the acquired photographing frame;
an evaluation unit configured to evaluate a whole photographing frame based on an evaluation condition set for each object within the photographing frame which has been identified; and
an output unit configured to output an evaluation result of the evaluation unit to the photographing apparatus as support information.

18. A storage medium storing a program used for causing an information processing apparatus to generate support information used for supporting photographing performed by a photographing apparatus, the program comprising:
evaluating a whole photographing frame based on an evaluation condition set for each object within the photographing frame, and
causing the information processing apparatus to generate the support information based on the evaluation.

19. A photographing apparatus presenting information used for supporting photographing performed by a photographer, the apparatus comprising:
an identification unit configured to identify an object within a photographing frame;
an evaluation unit configured to evaluate a whole photographing frame based on an evaluation condition set for each object within the photographing frame which has been identified; and
a presentation unit configured to present an evaluation result of the evaluation unit to a photographer as support information.
